(19) United States
(12) Patent Application Publication
(10) Pub. No.: US 2013/0332824 A1
(43) Pub. Date: Dec. 12, 2013

(54) EMBEDDED FONT PROCESSING METHOD AND DEVICE

(71) Applicants: Beijing Founder Apabi Technology Ltd., Beijing (CN); PEKING UNIVERSITY FOUNDER GROUP CO., LTD., Beijing (CN)

(72) Inventors: Li DING, Beijing (CN); Ruiheng Qiu, Beijing (CN); Lei Zhang, Beijing (CN)

(21) Appl. No.: 13/913,631

(22) Filed: Jun. 10, 2013

(30) Foreign Application Priority Data
Jun. 11, 2012 (CN) 201210191967.3

(51) Int. Cl. G06F 17/21

(52) U.S. Cl. CPC G06F 17/214
USPC 715/269

(57) ABSTRACT

An embedded font processing method and device. Searching for an advance characteristic information corresponding to each embedded font in an original font library. Selecting, for each embedded font, at least one piece of the advance characteristic information as a key characteristic information that corresponds to the embedded font. All of the fonts corresponding to the key characteristic information are identified and a candidate font collection is generated therefrom. The font type that completely matches the embedded font in the candidate font collection is identified.

### FIELD OF THE INVENTION

The present invention relates to text processing, and more particularly, to an embedded font processing method and device.

### BACKGROUND OF THE INVENTION

In an electronic document, to ensure consistency of display on different platforms, font embedding is a widely used technical means in document processing, typography retrieval, Internet communication and the like. Typically, partial font data is extracted from an original font, and integrated to form a new font file. Such processing is referred to as font embedding, and the obtained new font is an embedded font. In general, the embedded font only includes partial font data required to display the text in the document thereby making the data size of the document file as small as possible. The embedded font may be considered a collection of a group of different glyphs. In addition the embedded font can include a mapping relationship between character encodings or glyph number and corresponding glyphs. A user can obtain a corresponding glyph through character encoding or a glyph number (index) for displaying. However, some embedded fonts do not include the mapping relationship between character encodings and glyphs.

The prior art exhibits some disadvantages.

Although embedded font can ensure document display consistency under different situations, there are many limitations in its use. For example, as data in a partial original embedded font is lost, text cannot be edited freely. For instance: if there are only the glyphs corresponding to the Chinese characters “ [symbol] ” and “ [symbol] ” in the original embedded font data and the glyph of the character “ [symbol] ” is absent, the character “ [symbol] ” cannot be edited into the corresponding text. When displaying a document, text can only be drawn from reading its corresponding embedded font. However, Chinese embedded font data generally has a large size, and this makes the display, or drawing speed of a document in a network environment slower. If the original font of the embedded font is known, transmission of the embedded font data can be skipped, thus increasing the document display speed in the network environment.

### SUMMARY OF THE INVENTION

The present invention provides an embedded font processing method and device that overcomes prior art difficulties that various applications cannot directly find corresponding original fonts according to the embedded font to edit text content due to the loss of partial original font data in the font embedding process. The present invention recognizes that since local existing original font data cannot be used to draw text, network transmission of embedded font data cannot be omitted.

The embedded font processing method of the present invention includes: obtaining each embedded font, and searching for an advance characteristic information of each embedded font (described below). For each embedded font, selecting as a key characteristic information, at least one piece of the advance characteristic information that corresponds to the embedded font. Fonts corresponding to the selected key characteristic information are identified, and a candidate font collection is generated. The font type in the candidate font collection that matches the embedded font is identified.

An embedded font processing device in accordance with the present invention includes: a searching module for obtaining each embedded font and searching for an advance characteristic information of each embedded font. A selecting module selects, as a key characteristic information, at least one piece of the advance characteristic information that corresponds to the embedded font for each embedded font. A first identifying module identifies fonts corresponding to the selected key characteristic information and generates a candidate font collection. A second identifying module identifies a font type in the candidate font collection that matches the embedded font.

Compared with the prior art, the present invention has the following advantages:

Embodiments of the present invention provide an embedded font processing technique wherein an original font library is searched for an advance characteristic information corresponding to an embedded font, and original font data matching the embedded font is identified. Thus, text may be further edited. Also, data transmission of the embedded font can be omitted, improving searching efficiency. The present invention is applicable to other applications that depend upon the original font data of the embedded font.

### BRIEF DESCRIPTION OF THE DRAWINGS

FIG. 1 is a schematic flowchart of the method performed by an embodiment of the present invention;

FIG. 2 is a schematic block diagram of a device in accordance with an embodiment of the present invention;

FIG. 3 is a schematic flowchart of a method performed by another embodiment of the present invention; and

FIG. 4 is a schematic diagram of the application of the present invention to Arabic characters and corresponding indexes.

### DETAILED DESCRIPTION OF THE EMBODIMENTS

The present invention provides an embedded font processing method and device, that addresses the problem that various applications cannot directly find corresponding original font according to the embedded font to edit text content due to the loss of partial original font data in the font embedding process. The present invention recognizes that as local existing original font data cannot be used to draw text, network transmission of embedded font data cannot be omitted.

The embedded font processing method of the present invention includes: obtaining each embedded font, and searching for an advance characteristic information of each embedded font. Examples of advance characteristic information are described below. For each embedded font, selecting as a key characteristic information, at least one piece of the advance characteristic information that corresponds to the embedded font. Fonts corresponding to the selected key characteristic information are identified and a candidate font collection is generated. The font type in the candidate font collection that matches the embedded font is identified.

The advance characteristic information includes at least one of the following: glyph change, glyph combination, vertical glyph transformation, one glyph to multiple characters, multiple glyphs to one character and multiple glyphs to multiple characters. Reference is made to the Microsoft typography website for open type specification, describing the glyph substitution table, which is incorporated herein by reference.

A correspondence mapping table of a character encoding and a glyph index of each glyph may be included in the advance characteristic information.

In accordance with one technique for searching for the advance characteristic information of each embedded font, in an original font library corresponding to each obtained embedded font, a glyph corresponding to the character encoding or the glyph index is searched in the advance characteristic information that matches the embedded font.

One embodiment for identifying a font type matching the embedded font in the candidate font collection includes: identifying a font completely matching the embedded font in the generated candidate font collection according to a mapping relation between character encodings and glyph indexes corresponding to the embedded font in regular characteristics of each embedded font. That is, one character encoding corresponds to one glyph index and this refers to the location of the glyph description in the font file. An example of regular characteristics is the cmap table described in the above-referenced Microsoft typography website.

Before searching for an advance characteristic information of each embedded font, it is determined whether the advance characteristic information corresponding to the embedded font exists in an original font library. For instance, the font file is parsed to determine if content other than the cmap table and glyph description information exist in that file. Taking true type as an example, the cmap table is necessary information and glyph description information (e.g., the cvt and glyph tables) are in the file. Advance characteristic information is additional information in the font file; such as the “Advanced Typographic Tables” in the above-mentioned Microsoft typography website. If the advance characteristic information does not exist in the original font library, a glyph is identified that completely matches the embedded font according to a mapping relation between corresponding character encodings and glyph indexes in regular characteristics.

As one embodiment of the present invention, an embedded font processing device, implemented by a programmed processor operating in accordance with the algorithm described below, includes a searching module, for obtaining each embedded font and searching for an advance characteristic information of each embedded font. A selecting module selects, as a key characteristic information, at least one piece of the advance characteristic information that corresponds to the embedded font for each embedded font. A first identifying module identifies fonts corresponding to the selected key characteristic information and a candidate font collection is generated. A second identifying module identifies the font type in the candidate font collection that matches the embedded font.

The device also includes a third identifying module, for further identifying a font in the generated font collection that completely matches the embedded font according to a mapping relation between character encodings and glyph indexes corresponding to the embedded font in regular characteristics of each embedded font, after the second identifying module identifies the font type matching the embedded font in the candidate font collection.

The device also includes a determining module, for determining whether the advance characteristic information corresponding to the embedded font exists in an original font library. If it does not, the third identifying module identifies a glyph that completely matches the embedded font according to a mapping relation between corresponding character encodings and glyph indexes in regular characteristics, before the searching module searches for an advance characteristic information of each embedded font.

A detailed description of the embodiments of the present invention now will be described in connection with the drawings.

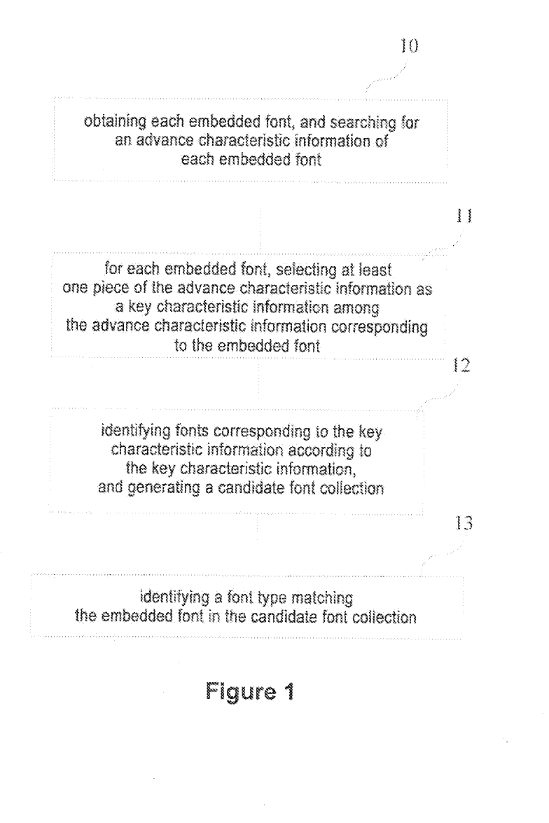

FIG. 1 illustrates a flowchart of an embedded font processing method in accordance with the present invention, including the following steps:

S10: Obtaining each embedded font, as may be provided by the data file associated with an electronic document and searching for an advance characteristic information of each embedded font;

S11: For each embedded font, selecting at least one piece of the advance characteristic, from the advance characteristic information corresponding to the embedded font, as a key characteristic information;

S12: Identifying fonts corresponding to the selected key characteristic information, and generating a candidate font collection from the identified fonts; and

S13: Identifying a font type in the candidate font collection that matches the embedded font.

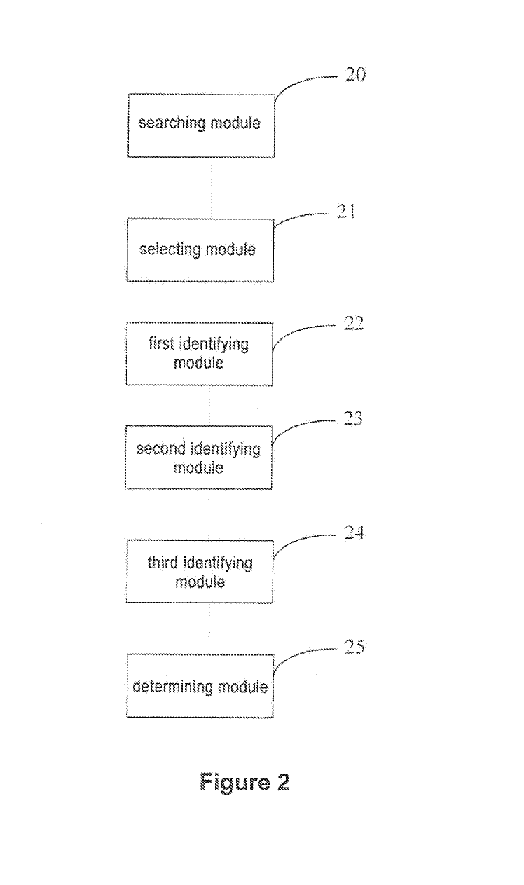

FIG. 2 is a schematic structural block diagram of a device in accordance with one embodiment of the present invention. In FIG. 2, the illustrated device includes: a searching module 20, for obtaining each embedded font and searching for an advance characteristic information of each embedded font. A selecting module 21 selects at least one piece of the advance characteristic information from the advance characteristic information found by the searching module 20. The selected piece (or pieces) of advance characteristic information correspond to the embedded font for each embedded font. A first identifying module 22 identifies fonts corresponding to the key characteristic information selected by module 21 and generates a candidate font from the identified fonts. A second identifying module 23, identifies a font type in the candidate font collection that matches the embedded font.

The device of FIG. 2 further includes a third identifying module 24 that identifies a font in the generated candidate font collection that completely matches the embedded font based on a mapping relation between character encodings and glyph indexes corresponding to the embedded font in regular characteristics of each embedded font, after the second identifying module 23 identifies the font type in the candidate font collection that matches the embedded font.

The device further includes a determining module 25 for determining whether the advance characteristic information corresponding to the embedded font as selected by the selecting module 21, exists in an original font library. If the advance characteristic information does not exist, the third identifying module 24 is caused to identify a glyph that completely matches the embedded font according to a mapping relation between corresponding character encodings and glyph indexes in regular characteristics, before the searching module 20 searches for an advance characteristic information of each embedded font.

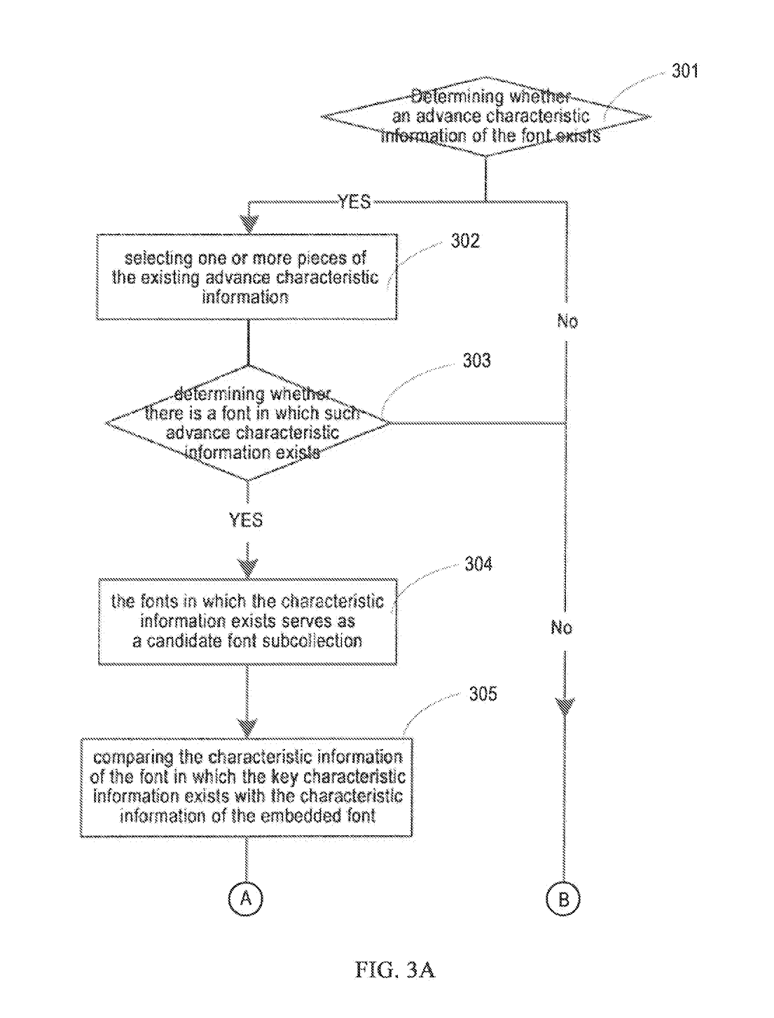

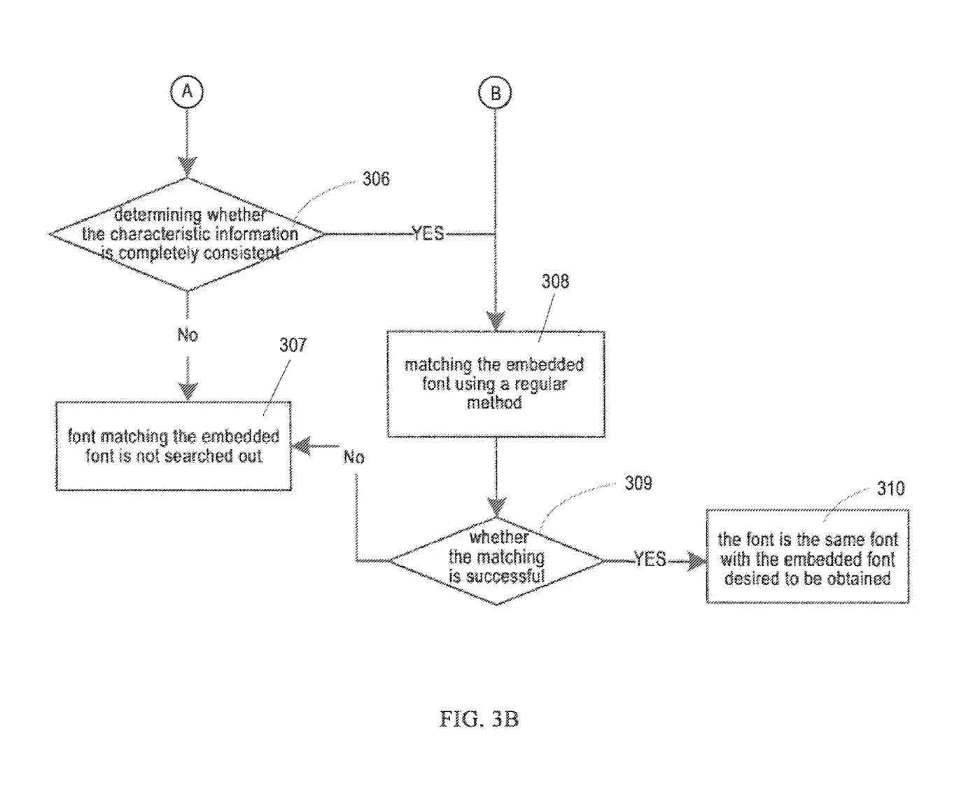

FIG. 3 is a schematic flowchart in accordance with another embodiment of the present invention. The method represented by FIG. 3 includes the following steps:

S301: Determining whether an advance characteristic information of a font exists. This determination is made by searching for whether the advance characteristic information of a font is included in an original font library, such as by using a vertical glyph transformation table, finding a one-to-many (many-to-one or many-to-many) relationship between characters and glyphs, ornamental characters, etc. A vertical punctuation transformation table is described below.

When it is determined that the advance characteristic information of a font exists, step S302 is executed: selecting one or more pieces of the existing advance characteristic information as a key characteristic information found by the search;

S303: For all fonts of a font library, determining there is a font in which the selected piece (or pieces) of characteristic information exists;

When it is determined that it exists, step S304 is executed: the fonts in which the characteristic information exist serve as a candidate font subcollection;

When determining that the selected piece (or pieces) of characteristic information of step S302 does not exist, step S308 is executed: matching the embedded font by using a regular method. For example, if characters having two fonts are selected, two glyph descriptions for each character are found from their respective font files according to the character encoding. These two glyph descriptions are compared to determine if they conform to each other. For example, the coordinates of each dot and line of the two glyphs are compared for conformity.

In step S305, the characteristic information of the font in which the key characteristic information exists is compared with the characteristic information of the embedded font.

Then, step S306 is performed to determine whether the key characteristic information is completely consistent with the characteristic information of the embedded font.

When it is determined that the included key characteristic information is completely consistent with the characteristic information of the embedded font, step S308 is executed: matching the embedded font by using a regular method.

However, if it is determined that the included characteristic informations are not consistent with each other, step S307 is executed: there is no search for a font matching the embedded font.

When it is determined that no advance characteristic information exists for the fonts of a font library, that is, inquiry 301 is answered in the negative, step S308 is executed: matching the embedded font using a regular method. Then, step S309 is performed: determining whether the matching is successful.

When it is determined that the matching is successful, step S310 is executed: the font is the same font as the embedded font.

When it is determined that the matching is not successful, step S307 is executed: font matching the embedded font is not searched.

:

As one example, assume that an embedded font A obtained from font Song (simsun.tif) includes a mapping relationship between character encodings and glyphs, and includes a vertical punctuation transformation table in advance characteristics.

Taking the below vertical punctuation transformation table in the advance characteristics as an example:

| Character encoding | Glyph index | Glyph |
|---|---|---|
| “ | 2509 | [symbol] |
| ” | 2510 | [symbol] |
| [symbol] [symbol] | [symbol] [symbol] | [symbol] [symbol] |

According to the above vertical punctuation transformation table, it can be determined that the characteristic information of the advance characteristics exists in five fonts including “Song”, “Bold”, “Young circle”, etc.

Detailed characteristic information is obtained to compare the five fonts, and it is found that ““” corresponds to “ [symbol] ” and “”” corresponds to “ [symbol] ” in all these five fonts.

The glyph features of corresponding “ [symbol] ” and “ [symbol] ” are compared to identify which fonts are identical to the embedded font A. If it is determined that only font Song is identical to the embedded font, it is determined that the embedded font A may be a subcollection of font Song.

To ensure matching accuracy, the embedded font can be further compared with the other mapping relations between character encodings and glyph indexes of font Song as well as glyph information to further determine the font which matches the embedded font A.

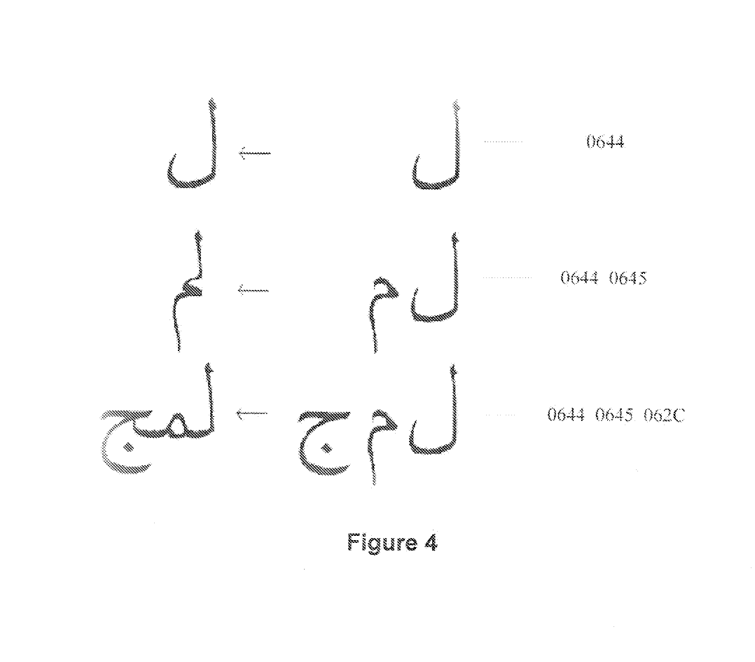

As another example, assume that embedded font B obtained from an Arabic font includes some Arabic characters as shown in FIG. 4, which is a schematic diagram of Arabic characters and corresponding indexes. When an Arabic character exists sequentially with other characters, that character may correspond to other glyphs when displayed. For example, when the character shown in FIG. 4A corresponding to index 0644 exists with character 0645 at the same time, they are displayed as another glyph (see FIG. 48), and while characters 0644, 0645 and 062C exist sequentially (see FIG. 4C), these three characters are displayed as one glyph.

According to the above advance characteristics, it can be identified that through comparison, only font C conforms to the corresponding relationship in the above table.

Then determining whether the glyph features of “ [symbol] ” and “ [symbol] ” in the font C are the same as the embedded font B, if the glyph features are determined to be the same, the font C can be identified as the same font as the embedded font B.

For higher accuracy, the embedded font B and the font C can be further determined by using a regular method.

As a further example, according to the alternative characters [symbol] →& [symbol] for aesthetics, the display of different characters under different situations is used as an advance characteristic information, and a search is performed. The search method is the same as described above and is not repeated here.

As yet another example, when presented at different locations, a letter is displayed in different forms, for example, consider the Arabic letter: [symbol] . The four glyphs correspond to the different display of the same letter presented; alone, at the beginning, in the middle and at the end, respectively, of the text and a search is performed. The search method is the same as described above and is not repeated here.

It is seen that the present invention searches for an embedded font according to the above advance characteristic information of fonts. Original data matching the corresponding embedded font is searched in order to edit and draw the text freely, and to speed up the display speed in the network environment when text is transmitted.

The present invention has been described with reference to the methods, devices (systems), and the flowchart and/or block diagram of a programmed computer according to the embodiments of the present invention. It should be understood that each step and/or block, and the combination of steps and/or blocks, of the flowchart and/or block diagram may be implemented by instructions of a computer program. These instructions of the computer program may be provided to a general purpose computer, a dedicated computer, an embedded processor, or other processor of a programmable data processing device to produce a machine, such that the instructions which are performed by the computer or other processor implement the functions designated by one or more steps in the flowchart and/or one or more blocks in the block diagram.

These instructions of the computer program may be stored in a non-transitory computer readable memory which instruct the computer or other programmable data processing device to function in the particular manner described above, such that the instructions stored in the computer readable memory produce a product including an instruction device. The instruction device implements the functions designated by one or more steps in the flowchart and/or one or more blocks in the block diagram.

These instructions of the computer program may also be loaded to the computer or other programmable data processing device, such that a series of operating procedures is performed on the computer or other programmable data processing device to produce processing implemented by a computer. As such, the instructions performed on the computer or other programmable data processing device provide the procedures used to implement the functions designated by one or more steps in the flowchart and/or one or more blocks in the block diagram.

While the preferred embodiments of the present invention have been described, once a person skilled in the art appreciates the basic inventive concept herein, additional variations and modifications can be made to these embodiments. Therefore, the following claims are intended to be interpreted to include preferred embodiments and all variations and modifications within the scope of the present invention.

Obviously, various modifications and variations can be made by the person skilled in the art without departing from the spirit and scope of the present invention. As such, if these modifications and variations of the present invention come within the scope of the claims and their equivalents, it is intended that the present invention cover such modifications and variations.

1. An embedded font processing method, comprising:
obtaining each embedded font;
searching for an advance characteristic information of each embedded font;
selecting, for each embedded font, at least one piece of the advance characteristic information as a key characteristic information that corresponds to the embedded font;
identifying fonts corresponding to the selected key characteristic information;
generating a candidate font collection from the identified fonts; and
identifying a font type that matches the embedded font in the candidate font collection.

2. The method of claim 1, wherein the advance characteristic information includes at least one of glyph change, glyph combination, vertical glyph transformation, one glyph to multiple characters, multiple glyphs to one character, or multiple glyphs to multiple characters.

3. The method of claim 2, wherein the advance characteristic information further includes a correspondence mapping table of a character encoding and a glyph index of each glyph.

4. The method of claim 3, wherein the step of searching for the advance characteristic information of each embedded font comprises:
searching for a glyph corresponding to the character encoding or the glyph index in the advance characteristic information matching the embedded font for an original font library corresponding to each obtained embedded font.

5. The method of claim 1, wherein after a font type matching the embedded font in the candidate font collection is identified
a font completely matching the embedded font in the generated candidate font collection is identified according to a mapping relation between character encodings and glyph indexes corresponding to the embedded font in regular characteristics of each embedded font.

6. The method of claim 5, wherein before the step of searching for an advance characteristic information of each embedded font, the method includes:
determining whether the advance characteristic information corresponding to the embedded font exists in an original font library, and
identifying a glyph completely matching the embedded font according to a mapping relation between corresponding character encodings and glyph indexes in regular characteristics if the advance characteristic information does not exist in the original font library.

7. An embedded font processing device, comprised of a programmed processor that includes:
a searching module configured to obtain each embedded font;
a search module configured to search for an advance characteristic information of each embedded font;
a selecting module configured to select, for each embedded font, at least one piece of the advance characteristic information as a key characteristic information that corresponds to the embedded font;
a first identifying module configured to identify fonts corresponding to the selected key characteristic information and to generate a candidate font collection therefrom; and
a second identifying module configured to identify a font type that matches the embedded font in the candidate font collection.

8. The device of claim 7, wherein the advance characteristic information includes at least one of glyph change, glyph combination, vertical glyph transformation, one glyph to multiple characters, multiple glyphs to one character, or multiple glyphs to multiple characters.

9. The device of claim 8, wherein the advance characteristic information further includes a correspondence mapping table of a character encoding and a glyph index of each glyph.

10. The device of claim 9, wherein when the search module searches for a glyph corresponding to the character encoding or the glyph index in the advance characteristic information matching the embedded font for an original font library corresponding to each obtained embedded font.
